(19) United States
(12) Patent Application Publication
(10) Pub. No.: US 2012/0311331 A1
(43) Pub. Date: Dec. 6, 2012

(54) LOGON VERIFICATION APPARATUS, SYSTEM AND METHOD FOR PERFORMING LOGON VERIFICATION

(75) Inventor: Zhihui ZHANG, Beijing (CN)

(73) Assignee: Sony Corporation, Tokyo (JP)

(21) Appl. No.: 13/478,327

(22) Filed: May 23, 2012

(30) Foreign Application Priority Data
May 30, 2011 (CN) 201110157622.1

(51) Int. Cl. H04L 9/28

(52) U.S. Cl. 713/168

(57) ABSTRACT

An apparatus for performing logon verification comprising: an obtaining device configured to obtain from a user certificate, for a first logon verification, first encryption information, second encryption information, and first decryption data in first decryption information associated with the first logon verification, the first and second encryption information are obtained by encrypting unique identification of the user according to first and second encryption method, respectively; a decrypting device configured to decrypt, based on second decryption information associated with the first logon verification and the first decryption data, the second encryption information according to a decryption method corresponding to the second encryption method to obtain the identification; an encrypting device configured to encrypt the obtained identification according to the first encryption method to obtain third encryption information; and a verifying device configured to confirms the first logon verification successful if the first and third encryption information are identical.

### TECHNICAL FIELD OF THE INVENTION

The invention generally relates to a multiple logon verification technology, and more particularly to a logon verification apparatus and method for performing logon verification.

### BACKGROUND ART OF THE INVENTION

A computing device such as a personal computer, a notebook computer and a server and an electronic device such as a smart appliance and a wireless communication terminal may provide users with capability of accessing a variety of functions, services and resources through various interfaces such as display and various connections such as the Internet. Accordingly, there is a need to provide a mechanism for limiting and allowing a user's access to those functions, services and resources.

User logon mechanisms performing logon verification prior to allowing user's access to functions, services and resources have been provided. For example, in DoS operating system and Windows operating system, a user performs logon verification using logon name and verification password (PWD). This kind of systems usually perform data changes on preset user name and verification password, such as computing Hash, and stores the computing result into a computer device for use in a user's next logon verification.

With the increasing popularity of information technology, there are more and more situations where a user needs to perform logon verification. A user needs to remember a large number of different pairs of user name and verification password. Accordingly, an OpenID technology performing multiple logon verification using a single network name and password is provided, for example, please make reference to http://en.wikipedia.org/wiki/OpenID. In the OpenID system, a user is identified by using URI (uniform resource identifier) (that is, OpenID user name), and the user's verification password is stored on the OpenID service website. When a website supporting OpenID is logged on, a registered OpenID user name is input, and then a website that a user currently logs on will jump to OpenID service website. When the user inputs verification password on a logon verification interface provided by OpenID service website and the verification is successful, the user will return to the logon website and has logged on successfully.

### SUMMARY OF THE INVENTION

Verification process in an OpenID system is completed by an OpenID service website, that is, only this service website can verify a user's identity, and other service nodes which take participation in this system have to trust this service website unconditionally. If there is a cheater personating the OpenID service website, an authorized user may bypass the logon verification. In actual practice, many independent nodes need to verify a visitor's identity independently, but a visitor himself is not willing to configure several certificates repeatedly. Therefore, there is a need for a mechanism which ensures that a visitor only needs to possess a unique verification certificate, and allows that different access nodes verify the certificates independently.

According to one aspect of the invention, a logon verification apparatus is provided, the apparatus comprising: an obtaining device which obtains first encryption information, second encryption information, and that of all the first decryption information which is associated with the logon verification in user's certificate, wherein the first encryption information is obtained by encrypting the user's unique identification according to a first encryption method, the second encryption information is obtained by encrypting the identification according to a second encryption method; a decrypting device which decrypts, based on second decryption information associated with the logon verification and the first decryption information associated with the logon verification, the second encryption information according to a decryption method corresponding to the second encryption method to obtain the identification; an encrypting device which encrypts the identification according to the first encryption method to obtain third encryption information; and a verifying device which compares the first encryption information with the third encryption information, wherein in case that the first encryption information is identical to the third encryption information, the verifying device confirms that the logon verification is successful and allows the user to access corresponding functions.

According to another embodiment, the apparatus may further comprise a receiving device which receives from another apparatus a notification of being about to perform another logon verification on the another apparatus, wherein the obtaining device is further configured to obtain content of the certificate in response to the notification; and a transmitting device which transmits to the another apparatus the obtained content of the certificate.

According to another embodiment, the obtaining device may include: a transmitting unit which transmits to another apparatus a notification of being about to perform a logon verification on the logon verification apparatus; and a receiving unit which receives from the another apparatus content of the certificate returned in response to the notification.

According to another embodiment, a verifying device may also confirm that the logon verification is successful and allow the user to access corresponding functions in case that the first encryption information is identical to the third encryption information and the identification is not revoked.

According to another embodiment, taking G₁ as a bilinear group whose order is a prime number p, g is a generator of G₁, e:G₁×G₁→G₂ is representative of a bilinear mapping, a first encryption method is to apply a one-way function, the second encryption information is ID·Y^{r}, wherein ID is representative of the identification, Y=e(g, g)^{y}, the first decryption information is g^{t·r}, wherein corresponding t values of different first decryption information are different from each other, the second decryption information is g^{y/t}, wherein second decryption information and first decryption information associated with the same logon verification correspond to the same t value, t, r, y are random numbers in Zₚ domain, a decryption method corresponding to the second encryption method is ID·Y^{r}/e(g^{y/t}, g^{t·r}).

According to another embodiment, all first decryption information are encrypted into an inseparable form, and the obtaining device comprises: a decrypting unit which decrypts said all first decryption information into a separable form in case that the first decryption information associated with the logon verification is to be obtained.

According to another aspect of the invention, a method of performing logon verification is provided, the method comprising: obtaining first encryption information, second encryption information, and that of all the first decryption information which is associated with the logon verification in a user's certificate, wherein the first encryption information is obtained by encrypting the user's unique identification according to a first encryption method, the second encryption information is obtained by encrypting the identification according to a second encryption method; decrypting, based on second decryption information associated with the logon verification and the first decryption information associated with the logon verification, the second encryption information according to a decryption method corresponding to the second encryption method to obtain the identification; encrypting the identification according to the first encryption method to obtain third encryption information; and comparing the first encryption information with the third encryption information, wherein in case that the first encryption information is identical to the third encryption information, confirming that the logon verification is successful and allowing the user to access corresponding functions.

According to another embodiment, the method may further include: receiving from an apparatus a notification of being about to perform another logon verification on the apparatus; obtaining content of the certificate in response to the notification; and transmitting to the apparatus the obtained content of the certificate.

According to another embodiment, the obtaining step may include: transmitting to an apparatus a notification of being about to perform a logon verification; and receiving from the apparatus content of the certificate returned in response to the notification.

According to another embodiment, a verifying step may comprise confirming that the logon verification is successful and allowing the user to access corresponding functions in case that the first encryption information is identical to the third encryption information and identification is not revoked.

According to another embodiment, taking G1 as a bilinear group whose order is a prime number p, g is a generator of G1, e:G₁×G₁→G₂ is representative of a bilinear mapping, a first encryption method is to apply a one-way function, the second encryption information is ID·Y^{r}, wherein ID is representative of the identification, Y=e(g, g)^{y}, the first decryption information is g^{t·r}, wherein corresponding t values of different first decryption information are different from each other, the second decryption information is g^{y/t}, wherein second decryption information and first decryption information associated with the same logon verification correspond to the same t value, t, r, y are random numbers in Zₚ domain, a decryption method corresponding to the second encryption method is ID·Y^{r}/e(g^{y/t}, g^{t·r}).

According to another embodiment, all first decryption information are encrypted into an inseparable form, and obtaining first decryption information associated with the logon verification comprises: decrypting said all first decryption information into a separable form.

According to another aspect of the invention, a logon verification system is provided, the system comprising: an authorizing center which provides a user with a certificate, and provides an apparatus which performs corresponding logon verification with second decryption information associated with the corresponding logon verification, the certificate including first encryption information, second encryption information, and first decryption information associated with corresponding logon verification, wherein the first encryption information is obtained by encrypting the user's unique identification according to a first encryption method, the second encryption information is obtained by encrypting the identification according to a second encryption method; and the apparatus, each of the apparatus comprising: an obtaining device which obtains first encryption information, second encryption information, and that of all the first decryption information which is associated with the logon verification to be performed in a user's certificate; a decrypting device which decrypts, based on second decryption information associated with the logon verification to be performed and first decryption information associated with the logon verification to performed, the second encryption information according to a decryption method corresponding to the second encryption method to obtain the identification; an encrypting device which encrypts the identification according to the first encryption method to obtain third encryption information; and a verifying device which compares the first encryption information with the third encryption information, wherein in case that the first encryption information is identical to the third encryption information, the verification device confirms that the logon verification is successful and allows the user to access corresponding functions.

According to another embodiment, one of the apparatus may further comprise a receiving device which receives from another apparatus among the apparatus a notification of being about to perform another logon verification on the another apparatus, wherein the obtaining device of the one apparatus is further configured to obtain content of the certificate in response to the notification; and a transmitting device, which transmits to the another apparatus the obtained content of the certificate, and wherein the obtaining device of the another apparatus comprises: a transmitting unit which transmits to the one apparatus a notification of being about to perform another logon verification on the another apparatus; and a receiving unit which receives from the one apparatus content of the certificate returned in response to the notification.

According to another embodiment, the verifying device may be further configured to confirm that the logon verification is successful and allow a user to access corresponding functions in case that the first encryption information is identical to the third encryption information and the identification is not revoked.

According to another embodiment, taking G1 as a bilinear group whose order is a prime number p, g is a generator of G1, e:G₁×G₁→G₂ is representative of a bilinear mapping, a first encryption method is to apply a one-way function, the second encryption information is ID·Y^{r}, wherein ID is representative of the identification, Y=e(g, g)^{y}, the first decryption information is g^{t·r}, wherein corresponding t values of different first decryption information are different from each other, the second decryption information is g^{y/t}, wherein second decryption information and first decryption information associated with the same logon verification correspond to the same t value, t, r, y are random numbers in Zₚ domain, a decryption method corresponding to the second encryption method is ID·Y^{r}/e(g^{y/t}, g^{t·r}).

According to another embodiment, the all first decryption information are encrypted into an inseparable form, and the obtaining device comprises: a decrypting unit which decrypts said all first decryption information into a separable form in case that the first decryption information associated with the logon verification is to be obtained.

According to another aspect of the invention, a method of performing logon verification is provided, the method comprising: providing a user with a certificate, and providing an apparatus which performs corresponding logon verification with second decryption information associated with the corresponding logon verification, the certificate including first encryption information, second encryption information, and first decryption information associated with corresponding logon verification, wherein the first encryption information is obtained by encrypting the user's unique identification according to a first encryption method, the second encryption information is obtained by encrypting the identification according to a second encryption method; and by one of the apparatus: obtaining first encryption information, second encryption information, and that of all the first decryption information which is associated with the logon verification in a user's certificate; decrypting, based on second decryption information associated with the logon verification to be performed and first decryption information associated with the logon verification to be performed, the second encryption information according to a decryption method corresponding to the second encryption method to obtain the identification; encrypting the identification according to the first encryption method to obtain third encryption information; and comparing the first encryption information with the third encryption information, wherein in case that the first encryption information is identical to the third encryption information, confirming that the logon verification is successful and allowing a user to access corresponding functions.

According to another embodiment, the method may further comprise: by the one apparatus: receiving from another apparatus among the apparatus a notification of being about to perform another logon verification on the another apparatus; obtaining content of the certificate in response to the notification; and transmitting to the another apparatus the obtained content of the certificate, and by the another apparatus: transmitting to the one apparatus a notification of being about to perform another logon verification on the another apparatus; receiving from the one apparatus content of the certificate returned in response to the notification; obtaining first encryption information, second encryption information, and that of all first decryption information which is associated with the another logon verification in user's certificate; decrypting, based on second decryption information associated with the another logon verification and the first decryption information associated with the another logon verification, the second encryption information according to a decryption method corresponding to the second encryption method to obtain the identification; encrypting the identification according to the first encryption method to obtain third encryption information; and comparing the first encryption information with the third encryption information, wherein in case that the first encryption information is identical to the third encryption information, confirming that the logon verification is successful and allowing the user to access corresponding functions.

According to another embodiment, the verification may comprise confirming that the logon verification is successful and allowing the user to access corresponding functions in case that the first encryption information is identical to the third encryption information and the identification is not revoked.

According to another embodiment, taking G1 as a bilinear group whose order is a prime number p, g is a generator of G1, e:G₁×G₁→G₂ is representative of a bilinear mapping, a first encryption method is to apply a one-way function, the second encryption information is ID·Y^{r}, wherein ID is representative of the identification, Y=e(g, g)^{y}, the first decryption information is g^{t·r}, wherein corresponding t values of different first decryption information are different from each other, the second decryption information is et, wherein second decryption information and first decryption information associated with the same logon verification correspond to the same t value, t, r, y are random numbers in Zₚ domain, a decryption method corresponding to the second encryption method is ID·Y^{r}/e(g^{y/t}, g^{t·r}).

According to another embodiment, all first decryption information are encrypted into an inseparable form, and the method further comprises decrypting said all first decryption information into a separable form in case that the first decryption information associated with the logon verification is to be obtained.

### BRIEF DESCRIPTION OF THE DRAWINGS

Referring to the following explanations of the present invention in conjunction with the Drawings, the above and other objects, features and advantages of the present invention will be understood more easily. In the Drawings, the same or corresponding technical features or components may be denoted by the same or corresponding reference sign. In the Drawings, sizes and relative positions of elements are not necessarily drawn in ratio.

FIG. 1 is a schematic view illustrating an overview of a logon verification system according to one embodiment of the invention.

FIG. 2 is a block diagram illustrating an exemplary structure of a logon verification apparatus according to one embodiment of the invention.

FIG. 3 is a schematic view illustrating an example of a correspondence between list items and service nodes.

FIG. 4 is a schematic view illustrating another example of a correspondence between a list item and a service node.

FIG. 5 is a flowchart illustrating an exemplary process of a method for performing logon verification according to one embodiment of the invention.

FIG. 6 is a block diagram illustrating an exemplary structure of a logon verification apparatus according to one embodiment of the invention.

FIG. 7 is a flowchart illustrating an exemplary process of a method for performing logon verification according to one embodiment of the invention.

FIG. 8 is a block diagram illustrating an exemplary structure of a logon verification apparatus according to one embodiment of the invention.

FIG. 9 is a flowchart illustrating an exemplary process of a method for performing logon verification according to one embodiment of the invention.

FIG. 10 is a block diagram illustrating an exemplary structure of a computer in which the invention is implemented.

### DETAILED DESCRIPTION OF THE SPECIFIC EMBODIMENTS

The embodiments of the present invention are described hereinafter in conjunction with the Drawings. It should be noted that representation and description of components and processes unrelated to the present invention and well known to one of ordinary skill in the art are omitted in the Drawings and the Description for the purpose of clearness.

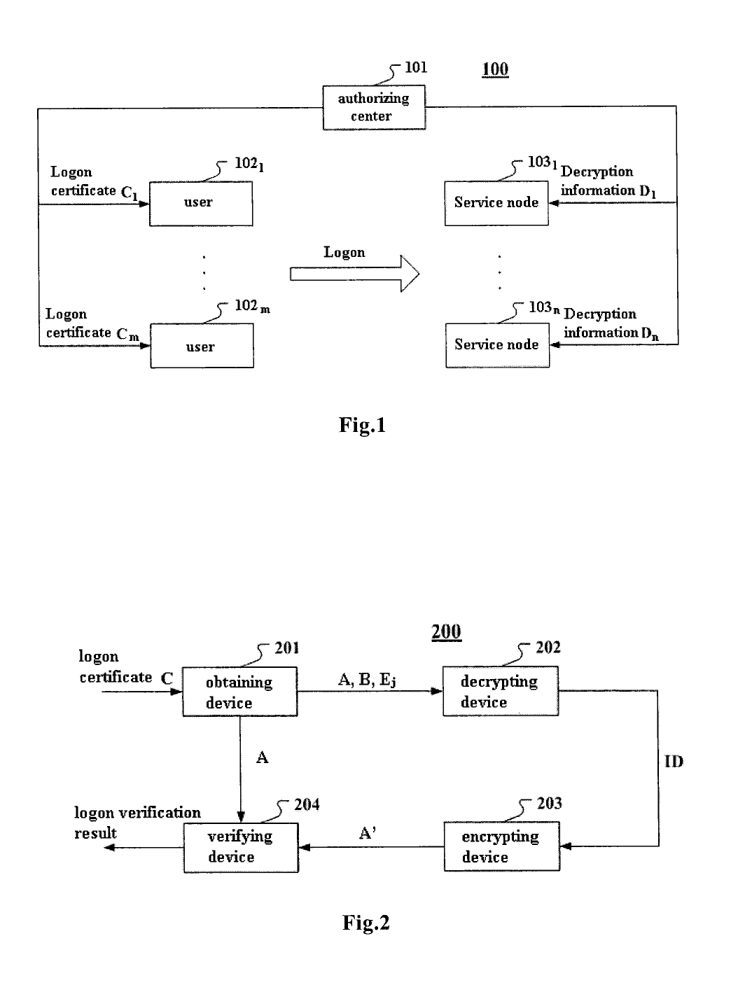

FIG. 1 is a schematic view illustrating an overview of a logon verification system 100 according to one embodiment of the invention.

As shown in FIG. 1, system 100 includes an authorizing center 101, user U₁ 102₁˜user Uₘ 102ₘ, and service node S₁ 103₁˜Sₙ 103ₙ.

A computing device such as a personal computer, a notebook computer and a server, an electronic device such as a smart appliance and a wireless communication terminal, and other apparatuses capable of processing information may provide users with capability of accessing a variety of functions, services and resources through various interfaces such as display and various connections such as the Internet. If those functions, services and resources can be allowed to be accessed only by an authorized user, the user can only access after he passes the logon verification. Different logon verification corresponds to corresponding functions, services, resources or their combinations (which are referred to functions for short herein). In case a user passes logon verification, the user is allowed to access corresponding functions, services, resources or their combinations. A service node corresponds to an apparatus performing logon verification on a user and allowing a user who passes the logon verification to access corresponding functions, services and resources providing on the service node.

For example, in case where a user starts his notebook computer and logs on the operating system as an administrator (that is, passing logon verification, such as inputting user name and password), the user is allowed to use or start various hardware and software resources on the notebook computer. Correspondingly, a service node corresponding to the logon verification is a notebook computer. For example, in case where a user starts an application installed on the notebook computer and passes the logon verification of the application, or a user logs on a WEB (World Wide Web) website through the notebook computer, service node corresponding to logon verification of the application is the notebook computer, and service node corresponding to the logon verification of the WEB site is an apparatus where the WEB website resides. For example, when a controller of an entrance guard system performs logon verification of a user, the service node is a device where the entrance guard system resides and the logon verification apparatus performing the logon verification is the controller.

It should be noted that the same logon verification apparatus may correspond to more than one service nodes. For example, on one server computer, logon verification is needed for entering the operating system, logon verification is needed for starting a WEB server, and logon verification is needed for entering a WEB website hosted by a WEB server. Therefore, the logon verification apparatus i.e. server computer, corresponds to three service nodes.

An authorizing center 101 generates decryption information D₁˜Dₙ for service nodes 103₁-103ₙ respectively. The authorizing center 101 generates corresponding logon certificates C₁˜Cₘ for user 102₁˜102ₘ respectively according to the authorization to access service nodes 103₁˜103ₙ obtained by user 102₁˜102ₘ.

For each user 102ᵢ, the authorizing center 101 registers a unique identification (ID) for the user. ID of the user may be generated by the authorizing center 101 or designated by the user, as long as the identification is unique and satisfies predetermined value requirement. The predetermined value requirement is depended on password used by the logon verification mechanism. Logon certificate Cᵢ of user 102ᵢ includes encryption information A, encryption information B and decryption information E={Eⱼ_{₁}, . . . , Eⱼ_{₁}}, j₁, . . . , jₜε{1, . . . , n}.

Encryption information A is obtained by encrypting a user's ID according to an encryption method CM₁, that is, A=CM₁(ID). The encryption method CM₁ may be based on any password scheme, for example, encryption method of symmetric key password, asymmetric key password. In addition, the encryption method CM₁ may also be one-way function F.

The encryption information B is obtained by encrypting a user's ID according to another encryption method CM₂, that is, B=CM₂(ID). As to a decryption information Eⱼ, ID can be obtained by decrypting, based on decryption information and decryption information Eⱼ associated with logon verification of service node 103ⱼ, encryption information B=CM₂(ID) according to a decryption method DM₂ corresponding to the encryption method CM₂. That is, ID=DM₂(B, Dⱼ, Eⱼ). The encryption method CM₂ and the decryption method DM₂ may be implemented in various manners. For example, encryption information B may be obtained by encrypting ID by key G, and in the event that there is no key G, key G is obtained based on decryption information Dⱼ and decryption information Eⱼ so as to decrypt the encryption information B.

It can be seen that decryption information Eⱼ included in the logon certificate C₁ means that a user 102ᵢ is authorized to access the service node 103ⱼ, that is, being allowed to pass logon verification of the service node 103ⱼ.

When a user who obtains logon certificate from an authorizing center 101 accesses a service node that is authorized to be accessed, the user may pass the logon verification of the service node by showing the logon certificate. Logon certificate may be stored and obtained in various manners. For example, logon certificate may be stored in storage medium such as magnetic disk, optical disk, memory card, logon certificate stored in storage medium may also be read locally, and read logon certificate is transmitted by communication connection such as wired connection and wireless connection to a position where logon verification is performed.

FIG. 2 is a block diagram illustrating an exemplary structure of a logon verification apparatus 200 according to an embodiment of the invention.

As shown in FIG. 2, the logon verification apparatus 200 includes an obtaining device 201, a decrypting device 202, an encrypting device 203 and a verifying device 204. When a user U requests to access functions, services or resources of a service node with logon verification apparatus 200, the apparatus 200 may prompt the user U to show his logon certificate C and perform logon verification on the logon certificate C. After passing of the logon verification, the apparatus 200 allows a user U to access desired functions, services or resources.

The obtaining device 201 obtains, in user's logon certificate C, encryption information A, encryption information B and decryption information Eⱼ, in the decryption information E, associated with logon verification V to be performed, that is, associated with service node 103ⱼ (that is, apparatus 200) performing the logon verification V.

The decryption information Eⱼ may be associated with the logon verification V, that is, service node performing the logon verification in various manners.

According to one manner, a list may be included in the logon certificate, each item in the list corresponding to one of all the service nodes. Each service node is aware of position of a list item corresponding thereto (for example, a sequence number). In such a case, if one list item does not include decryption information, it is indicated that the logon certificate does not include authorization to access a corresponding service node. Content including list item of decryption information may be referred to nonempty decryption information, and content not including list item of decryption information may be referred to as empty decryption information.

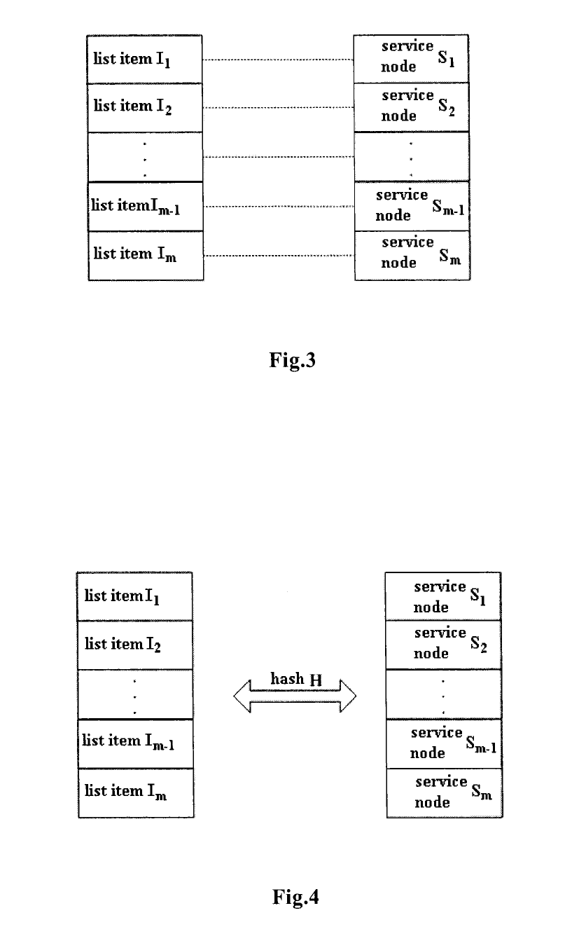

FIG. 3 illustrates a simple example, in which a correspondence between list items and service nodes is denoted by dot line. As shown in FIG. 3, sequence number i of corresponding list item Iᵢ of service node Sᵢ in the list is equal to sequence number i of service node Sᵢ.

FIG. 4 illustrates a more complicated example, in which sequence number k of corresponding list item Iₖ of service node Sᵢ in the list is hash value H(i) of sequence number i of service node Sᵢ.

According to another manner, in the logon certificate, each piece of decryption information Eⱼ may be attached with or associated with a unique identification, each service node (for example, apparatus 200) being aware of correspondence between the logon certificate of which the service node takes charge and the identification information of corresponding decryption information. Therefore, the identification information may be found in the logon certificate. If identification information is found, decryption information attached to or associated with the identification information may be found. In this case, the logon certificate may include nonempty decryption information only.

According to another manner, decryption information may be consisted of several parts, and these parts locate at different positions in the logon certificate. A corresponding service node (for example, apparatus 200) is aware of position of each part of the decryption information in the logon certificate.

It should be understood that the manners for association listed herein are illustratively, and manner of associating the decryption key with the service node is not limited to the manners listed herein.

The decrypting device 202 decrypts, based on decryption information Eⱼ associated with the logon verification V and decryption information from authorizing center 101, the encryption information B according to a decryption method DM₂ corresponding to the encryption method CM₂ to obtain a user's identification ID (that is, ID=DM₂(B, Dⱼ, Eⱼ)).

The encrypting device 203 encrypts identification ID according to encryption method CM₁ to obtain encryption information A′=CM₁(ID).

The verifying device 204 compares encryption information A and encryption information A′, and in the event that encryption information A is identical to the encryption information A′, determines that logon verification V is successful and allows a user to access corresponding function.

When there are more apparatuses for multiple service nodes shown in FIG. 2 (for example, service node Sᵢ_{ₗ}, . . . , Sᵢ_{ₕ}), if a user desires to access functions provided by those service nodes, the user may show his logon certificate C to those apparatuses, respectively. Obtaining devices of those apparatuses may respectively obtain encryption information A, B in the logon certificate C, and corresponding decryption information Eᵢ_{ⱼ}. Decrypting devices of those apparatuses respectively decrypt encryption information B using its decryption information Dᵢ_{ⱼ} and a corresponding decryption information Eᵢ_{ⱼ}, to obtain the user's identification ID. Encrypting devices of those apparatuses respectively encrypt identification ID according to encryption method CM₁ to obtain encryption information A′. Verifying devices of those apparatuses respectively determine whether encryption information A′ obtained by themselves is identical to encryption information A. If they are identical, the logon verification is successful. Therefore, a user can perform multiple logon verification by using a single logon certificate, and each logon verification is completed by each apparatus.

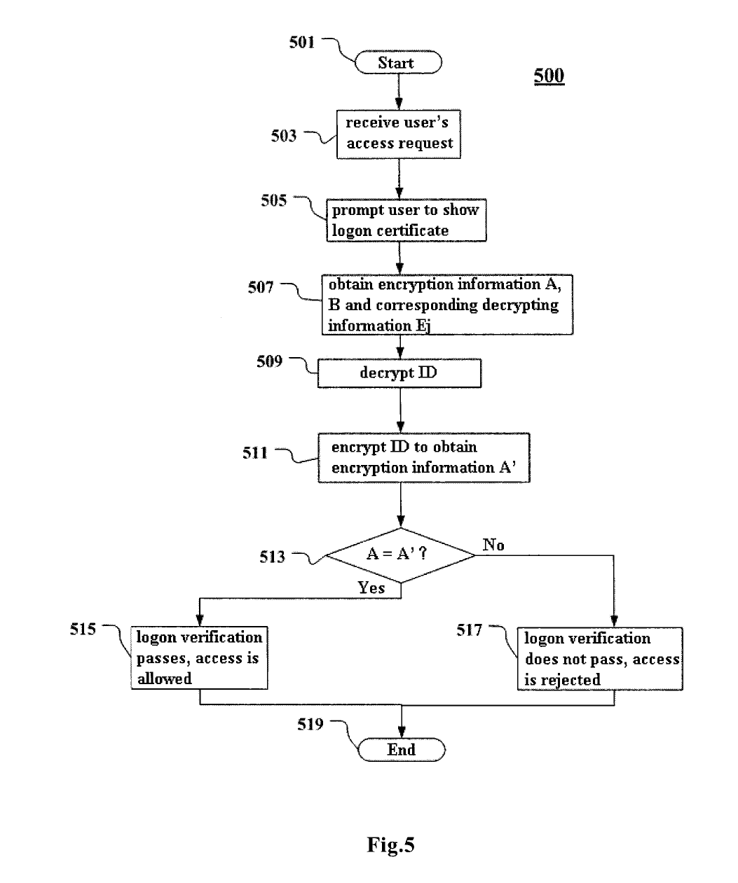

FIG. 5 is a flowchart illustrating an exemplary process of a method 500 for performing logon verification according to one embodiment of the invention.

As shown in FIG. 5, the method 500 starts at step 501. At step 503, a user's request or notification of accessing the service node is received.

At step 505, the user is prompt to show a logon certificate C. At step 507, encryption information A, encryption information B and decryption information Eⱼ associated with logon verification V to be performed in decryption information E in logon certificate C input by a user is obtained.

At step 509, based on decryption information Eⱼ associated with logon verification V and decryption information Dⱼ from an authorizing center, encryption information B is decrypted according to a decryption method DM₂ corresponding to the encryption method CM₂, so as to obtain a user's ID (that is, ID=DM₂(B, Dⱼ, Eⱼ)).

At step 511, identification ID is encrypted according to encryption method CM₁ to obtain encryption information A′=CM₁(ID).

At step 513, encryption information A is compared with encryption information A′. If encryption information A is identical to encryption information A′, at step 515, it is determined that logon verification V is successful, and the user is allowed to access corresponding functions. Then the method terminates at step 519.

In addition, at step 513, if encryption information A is different from the encryption information A′, at step 517, it is determined that logon verification V is unsuccessful and the user is rejected to access corresponding functions. Then the method terminates at step 519.

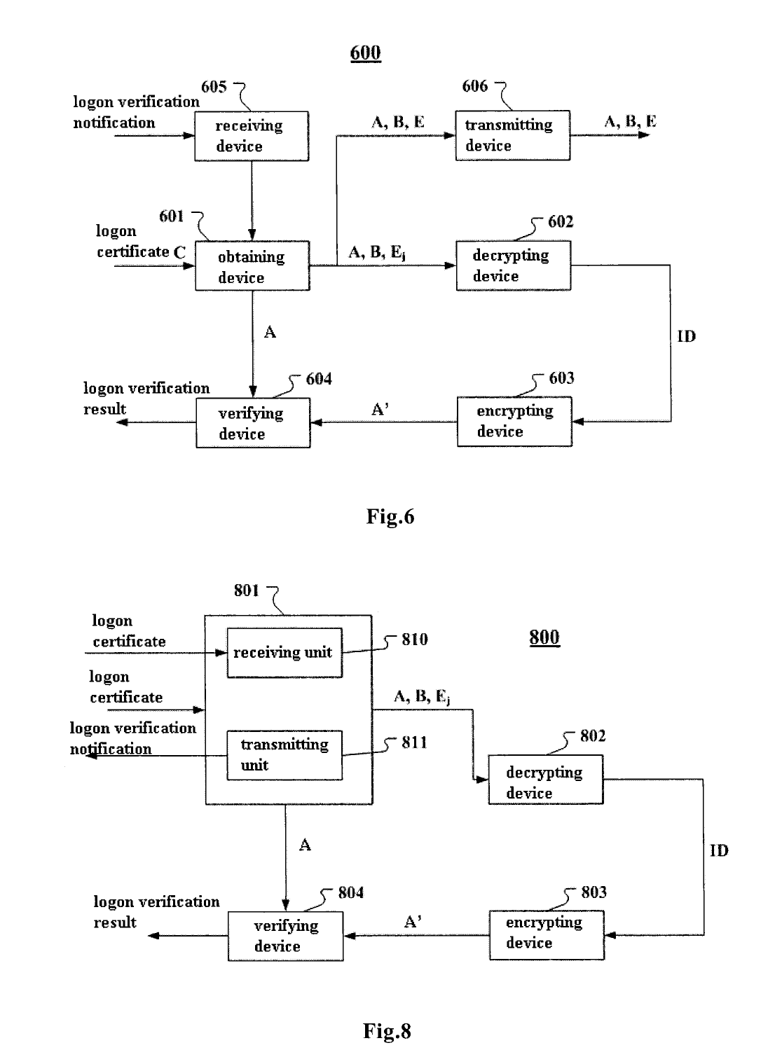

It should be noted that a logon verification apparatus may be used by a user to access another logon verification apparatus. FIG. 6 is a block diagram illustrating an exemplary structure of logon verification apparatus 600 according to an embodiment of the invention. The apparatus 600 shown in FIG. 6 may be used by a user to access another logon verification apparatus (for example, the apparatus 800 described hereinafter).

As shown in FIG. 6, the apparatus 600 includes obtaining device 601, decrypting device 602, encrypting device 603, verifying device 604, receiving device 605 and transmitting device 606. Decrypting device 602, encrypting device 603, and verifying device 604 are the same as decrypting device 202, encrypting device 203 and verifying device 204 shown in FIG. 2 in terms of function, respectively, and detailed descriptions are omitted herein.

When a user U requests to access functions, services or resources managed by an apparatus 600, the apparatus 600 may prompt a user U to show his logon certificate C and perform logon verification on the logon certificate C. At this time, obtaining device 601 obtains, from the user's logon certificate C, encryption information A, encryption information B and decryption information Eⱼ, in decryption information E, associated with logon verification V to be performed, that is, associated with service node 103ⱼ (that is, apparatus 600) performing the logon verification V. Then logon verification V is completed by decrypting device 602, encrypting device 603 and verifying device 604.

In addition, a user may access another logon verification apparatus by the apparatus 600. For instance, service provided by WEB website may be accessed by taking the apparatus 600 as a client. The function of accessing another apparatus provided by the apparatus 600 may be a function that is allowed to be used after the user passes the logon verification, or a function that is allowed to be used without logon verification.

To access functions of another apparatus, the apparatus 600 may transmit an access request to another apparatus. The another apparatus will return correspondingly a notification of requesting logon verification.

The receiving device 605 receives from another apparatus a notification relating to performing another logon verification on the another apparatus.

The obtaining device 601 is further configured to obtain content of the user certificate C in response to the notification. Then, the transmitting device 606 transmits to another apparatus the content of the obtained user certificate C.

After another apparatus's logon verification is passed, the another apparatus allows the user to access functions provided by the another apparatus through apparatus 600.

FIG. 7 is a flowchart illustrating an exemplary process of method 700 for performing logon verification according to one embodiment of the invention.

As shown in FIG. 7, method 700 starts at step 701. At step 703, it is determined whether a request that a user accesses the present apparatus or a request that the user accesses another apparatus through the present apparatus is received. If it is determined that a request that a user accesses the present apparatus is received, method 700 proceeds with step 705. The functions of step 705 and subsequent steps 707, 709, 711, 713, 715, 717 and 719 are the same as steps 505, 507, 509, 511, 513, 515, 517 and 519 described in conjunction with FIG. 5, and detailed descriptions thereof are omitted herein.

If it is determined at step 703 that the user requests to access another apparatus through the present apparatus, step 721 is performed. At step 721, a notification relating to performing another logon verification on another apparatus is received from the another apparatus.

At step 723, content of user certificate is obtained in response to the notification.

At step 725, the obtained content of user certificate is transmitted to the another apparatus.

Then the method is terminated at step 719.

According to the embodiments described in conjunction with FIGS. 6 and 7, a loose coupling is implemented between the present apparatus and another apparatus to avoid accessing the logon certificate by controlling the present apparatus directly by the another apparatus, thereby improving security of the present apparatus, and facilitating to perform logon verification across platforms.

When a user accesses an apparatus locally, the content of logon certificate may be input through an input device of the apparatus. When a user accesses an apparatus from a remote apparatus, the apparatus may read the content of logon certificate on the remote apparatus by means of such as proxy, plug-in, or remote control protocol. However, the remote apparatus may provide no corresponding support to implement such a manner. Therefore, the apparatus may obtain logon certificate by performing message communication with the remote apparatus to provide a path allowing a user to access from the remote apparatus.

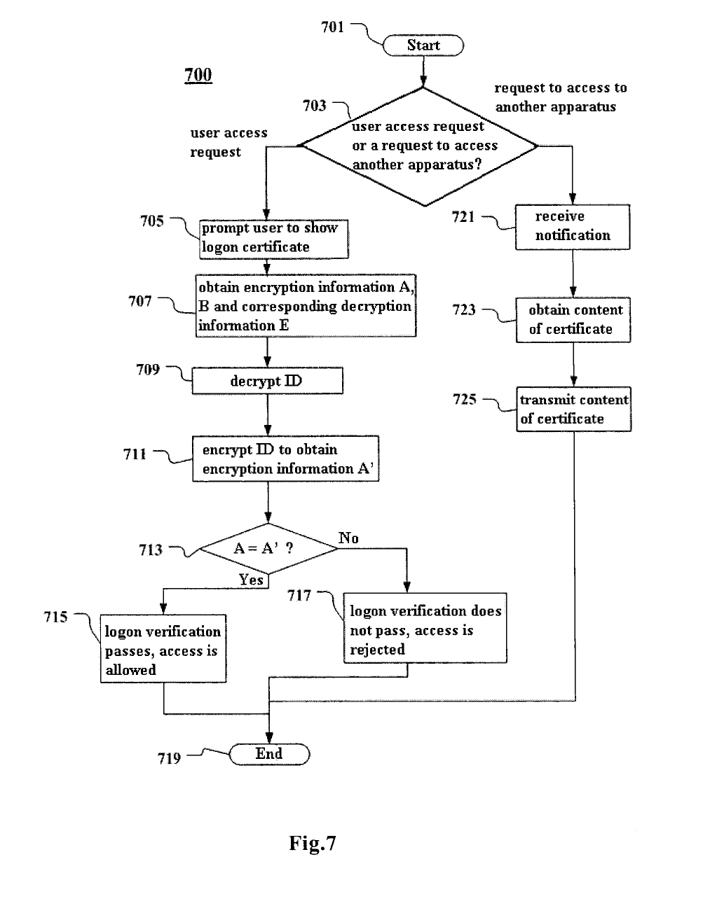

FIG. 8 is a block diagram illustrating an exemplary structure of a logon verification apparatus 800 according to an embodiment of the invention. The apparatus 800 shown in FIG. 8 may obtain logon certificate by performing message communication with another apparatus (for example, the apparatus 600).

As shown in FIG. 8, the apparatus 800 includes obtaining device 801, decrypting device 802, encrypting device 803, and verifying device 804. The functions of decrypting device 802, encrypting device 803, and verifying device 804 are the same as decrypting device 202, encrypting device 203 and verifying device 204 described in conjunction with FIG. 2, respectively, and detailed descriptions thereof are omitted herein.

When a local user U requests to access functions, services or resources managed by the apparatus 800, the apparatus 800 may prompt a user U to show his logon certificate C and perform logon verification on the logon certificate C. At this time, the obtaining device 801 obtains, from the user's logon certificate C, encryption information A, encryption information B and decryption information Eⱼ, in decryption information E, associated with logon verification V to be performed, that is, associated with service node 103ⱼ (that is, apparatus 800) performing the logon verification V. Then logon verification V is completed by decrypting device 802, encrypting device 803 and verifying device 804.

In addition, a remote user may access apparatus 800 remotely from another apparatus. Correspondingly, the obtaining device 800 may include transmitting unit 810 and receiving unit 811.

When a remote user desires to access apparatus 800 remotely from another apparatus, for example, in case where access request transmitted from another apparatus by a remote user is received, the transmitting unit 810 transmits to another apparatus a notification of being about to perform a logon verification on the apparatus 800. After the another apparatus receives the notification, content of user certificate is read locally and transmitted to the apparatus 800. Correspondingly, the receiving unit 811 receives from another apparatus content of logon certificate returned in response to the notification. The obtaining device 801 may obtain, from the received content of logon certificate, encryption information A, encryption information B and decryption information Eⱼ associated with the logon verification V to be performed in the decryption information E. Then logon verification is completed by decrypting device 802, encrypting device 803 and verifying device 804.

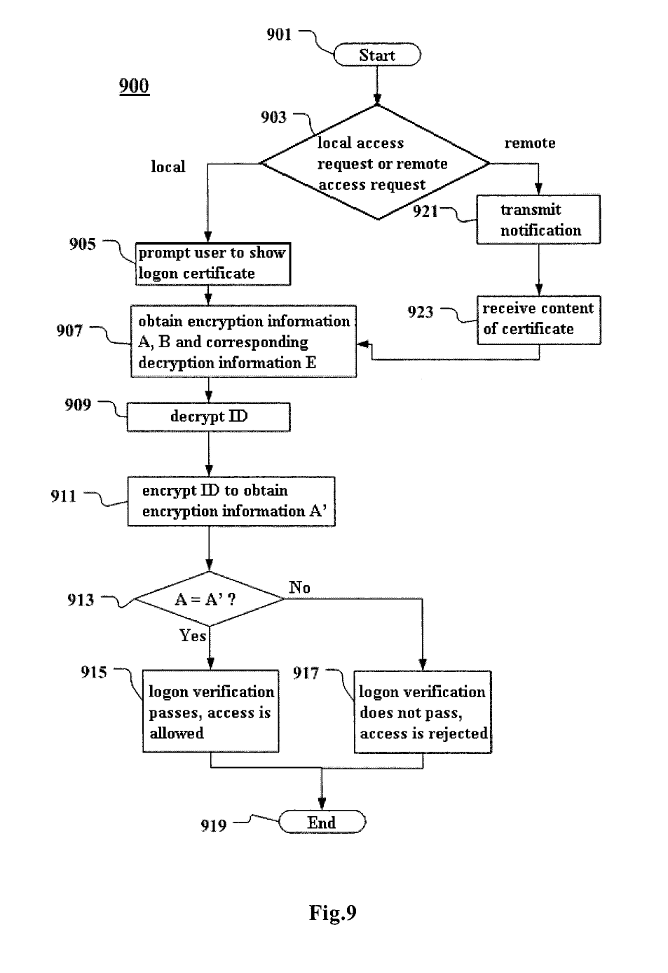

FIG. 9 is a flowchart illustrating an exemplary process of a method 900 for performing logon verification according to one embodiment of the invention.

As shown in FIG. 9, method 900 starts at step 901. At step 903, it is determined whether a request that a user accesses the present apparatus or a request that a user accesses the present apparatus through another apparatus is received. If it is determined that a request that a user accesses the present apparatus is received, the method 900 proceed with step 905. The functions of step 905 and subsequent steps 907, 909, 911, 913, 915, 917 and 919 are the same as steps 505, 507, 509, 511, 513, 515, 517 and 519 described in conjunction with FIG. 5, and detailed descriptions thereof are omitted herein.

If it is determined at step 903 that the user requests to access the present apparatus through another apparatus, step 921 is performed. At step 921, a notification of being about to perform a logon verification on the present apparatus is transmitted to the another apparatus. After the another apparatus receives the notification, content of user certificate is read locally and transmitted to the present apparatus. Correspondingly, at step 923, content of logon certificate returned in response to the above notification is received from the another apparatus. Then, proceed to step 907.

It should be understood that embodiments described in conjunction with FIGS. 6 and 8 may be combined, and embodiments described in conjunction with FIGS. 7 and 9 may be combined. That is, in the apparatus and method based on the above combinations, a user can complete logon verification of a remote device through the present apparatus to access the remote apparatus, or via message communication, a user may be allowed to use a remote device to pass the logon verification of the present application to access the present apparatus.

There may be cases where logon certificate needs to be revoked due to loss of logon certificate or cancellation of authorization. In such cases, the authorizing center may maintain information relating to the revoked user for example through a revoking list including IDs of revoked users. The authorizing center provides the information to each service node periodically, in response to change of information of revoked user (revoked or restored), or in response to query request. Alternatively, the service node may query from the authoring center about whether a specific user is revoked.

Correspondingly, in the apparatus according to an embodiment of the invention, the verifying device may also determine that the logon verification is successful and allow a user to access corresponding functions in case that the encryption information A is identical to the encryption information A′ and the identification is not revoked. The verifying device may determine whether the identification is revoked according to information relating to the revoked users provided from the authorizing center, or query from the authorizing center about whether the identification is revoked.

Correspondingly, in the method according to an embodiment of the invention, the verifying step may comprise determining that the logon verification is successful and allowing a user to access corresponding functions in case that the encryption information A is identical to the encryption information A′ and the identification is not revoked. Whether the identification is revoked may be determined according to information relating to the revoked users provided from the authorizing center, or whether the identification is revoked can be queried from the authorizing center.

In one specific implementation according to an embodiment of the invention, G₁ may be taken as a bilinear group whose order is a prime number p, g is a generator of G1, e:G₁×G₁→G₂ is representative of bilinear mapping. Encryption method CM₁ is a one-way function F. For a user who is uniquely identified as ID, encryption information A in his logon certificate is RID), and encryption information B is ID·Y^{r}, Y=e(g, g)^{y}.

As to each piece of decryption information Eⱼ included in logon certificate, Eⱼ=g^{t}^{ⱼ}^{·r}. Corresponding tⱼ values of different decryption information Eⱼ are different from each other.

Corresponding decryption information Dⱼ of each piece of decryption information Eⱼ is g^{y/t}^{ⱼ}, wherein, tⱼ, r, y are random numbers in Zₚ domain. A decryption method DM₂ is ID·Y^{r}/e(g^{y/t}^{ⱼ}, g^{t}^{ⱼ}^{·r})=ID·e(g, g)^{y·r}/e(g, g)^{(y/t}^{ⱼ}^{)·(t}^{·r)}=ID·e(g, g)^{y·r}/e(g, g)^{y·r}=ID.

Since decryption information E relates to authorization of a user, decryption information E in logon certificate may be encrypted into a form in which each piece of decryption information Eⱼ cannot be separated, so as to improve security of the logon certificate.

Such encryption can be implemented in various manners. For example, decryption information E (and/or related identification information, if any) may be encrypted into a data block, and each piece of decryption information Eⱼ can be separated only by decrypting the data block. For example, decryption information E (and/or related identification information, if any) may be disarranged into a data block, and each piece of decryption information Eⱼ can be separated only if the rule of the disarranging is known.

Correspondingly, in the apparatus according to an embodiment of the invention, the obtaining device may include a decrypting unit which decrypts all the decryption information E into a separable form in case that the decryption Eⱼ associated with the logon verification is to be obtained.

Correspondingly, in the apparatus according to an embodiment of the invention, the obtaining step may comprise decrypting all the decryption information E into a separable form in case that the decryption Eⱼ associated with the logon verification is to be obtained.

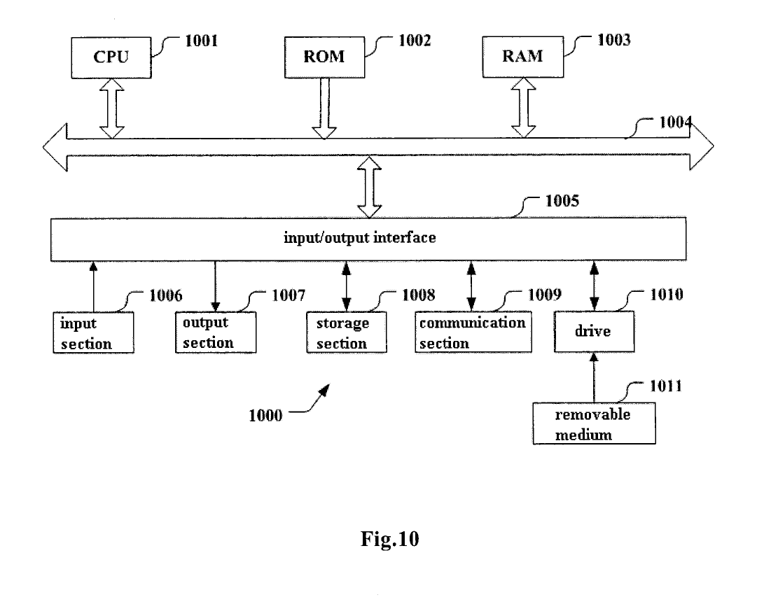

FIG. 10 is a block diagram illustrating an exemplary structure of a computer in which the invention is implemented.

In FIG. 10, a central processing unit (CPU) 1001 performs various processes according to the program stored in the Read-Only Memory (ROM) 1002 or programs loaded from the storage section 1008 to the Random Access Memory (RAM) 1003. In the RAM 1003, data required when the CPU 1001 performs various processes is also stored as needed.

CPU 1001, ROM 1002 and RAM 1003 are connected to each other via bus 1004. Input/output interface 1005 is also connected to the bus 1004.

The following components are connected to the input/output interface 1005: input section 1006, including keyboard, mouse, etc.; output section 1007, including display, such as cathode ray tube (CRT), liquid crystal display (LCD), etc., and speakers and so on; storage section 1008, including hard disc, etc.; and communication section 1009, including network interface cards such as LAN cards, modems and so on. The communication section 1009 performs communication process via network like the internet.

According to requirements, drive 1010 is also connected to the input/output interface 1005. Removable medium 1011 such as magnetic disk, optical disk, magneto-optical disk, semiconductor memory, and so on is installed on the drive 1010 based on requirements, such that the computer program read out therefrom is installed in the storage section 1008 based on requirements.

In case of implementing the above steps and processes by software, programs constituting the software are installed from a network like the Internet or from a storage medium like the removable medium 1011.

A person skilled in the art should be understood that such storage medium is not limited to the removable medium 1011 which is stored with programs and distributes separately from the method to provide a user with program as shown in FIG. 10. Example of the removable medium 1011 includes magnetic disk, optical disk (including compact disk read only memory (CD-ROM) and digital versatile disc (DVD)), magneto-optical disk (including mini-disk (MD)) and semiconductor memory. Alternatively, the storage medium may be ROM 1002, or hard disk included in the storage section 1008 in which a program is stored, and the program is distributed to a user with the method included therein.

The invention has been described above by referring to specific embodiments. However, an ordinary skill in the art should appreciate that various modifications and changes may be made without departing from the scope of the invention defined in the claims.

What is claimed is:

1. A logon verification apparatus, comprising:
an obtaining device configured to obtain from a certificate of a user, for a first logon verification, first encryption information, second encryption information, and first decryption data of first decryption information, wherein the first encryption information is obtained by encrypting an unique identification of the user according to a first encryption method, the second encryption information is obtained by encrypting the identification according to a second encryption method, the first decryption information comprises at least one piece of decryption data each associated with a corresponding logon verification and the first decryption data is associated with the first logon verification;
a decrypting device configured to decrypt, based on second decryption information associated with the first logon verification and the first decryption data, the second encryption information according to a decryption method corresponding to the second encryption method to obtain the identification;
an encrypting device configured to encrypt the identification obtained by the decrypting device according to the first encryption method to obtain third encryption information; and
a verifying device configured to compare the first encryption information with the third encryption information, and confirm the first logon verification successful in case that the first encryption information is identical to the third encryption information.

2. The logon verification apparatus according to claim 1, further comprising:
a receiving device configured to receive from another logon verification apparatus a notification notifying that the another logon verification apparatus is going to perform a second logon verification for the user, wherein the obtaining device is further configured to obtain content of the certificate in response to the notification; and
a transmitting device configured to transmit to the another logon verification apparatus the obtained content of the certificate.

3. The logon verification apparatus according to claim 1, wherein the obtaining device comprises:
a transmitting unit configured to transmit to another logon verification apparatus a notification notifying that the logon verification apparatus is going to perform the first logon verification for the user; and
a receiving unit configured to receive from the another logon verification apparatus content of the certificate returned in response to the notification.

4. The logon verification apparatus according to claim 1, wherein the verifying device is further configured to, in case that the first encryption information is identical to the third encryption information and the identification is not revoked, confirm that the logon verification is successful.

5. The logon verification apparatus according to claim 1, wherein G₁ is representative of a bilinear group whose order is a prime number p, g is a generator of G₁, e:G₁×G₁→G₂ represents a bilinear mapping, t, r, y are random numbers in Zₚ domain, and ID is representative of the identification, and
the first encryption method is to apply a one-way function to ID, the second encryption information is ID·Y^{r}, wherein Y=e(g, g)^{y},
the first decryption information is represented as g^{t·r}, wherein corresponding t values of different decryption data of the first decryption information are different from each other,
the second decryption information is represented as g^{y/t}, wherein second decryption information and decryption data associated with the same logon verification correspond to the same t value,
the decryption method corresponding to the second encryption method is ID·Y^{r}/e(g^{y/t}, g^{t·r}).

6. The logon verification apparatus according to claim 1, wherein said first decryption information is encrypted into an inseparable form, and
the obtaining device comprises:
a decrypting unit configured to decrypt said first decryption information into a separable form in order to obtain the first decryption data.

7. A method of performing logon verification, comprising:
obtaining from a certificate of a user, for a first logon verification, first encryption information, second encryption information, and first decryption data of first decryption information, wherein the first encryption information is obtained by encrypting an unique identification of the user according to a first encryption method, the second encryption information is obtained by encrypting the identification according to a second encryption method, the first decryption information comprises at least one piece of decryption data each associated with a corresponding logon verification and the first decryption data is associated with the first logon verification;
decrypting, based on second decryption information associated with the first logon verification and the first decryption data, the second encryption information according to a decryption method corresponding to the second encryption method to obtain the identification;
encrypting the obtained identification according to the first encryption method to obtain third encryption information; and
comparing the first encryption information with the third encryption information, and confirming the first logon verification successful in case that the first encryption information is identical to the third encryption information.

8. The method of performing logon verification according to claim 7, further comprising:
receiving from an logon verification apparatus a notification notifying that the logon verification apparatus is going to perform a second logon verification for the user;
obtaining content of the certificate in response to the notification; and
transmitting to the logon verification apparatus the obtained content of the certificate.

9. The method of performing logon verification according to claim 7, wherein the obtaining comprises:
transmitting to an logon verification apparatus a notification notifying that the first logon verification for the user is going to be performed; and
receiving, from the logon verification apparatus, content of the certificate returned in response to the notification.

10. The method of performing logon verification according to claim 7, wherein G₁ is representative of a bilinear group whose order is a prime number p, g is a generator of G₁, e:G₁×G₁→G₂ represents a bilinear mapping, t, r, y are random numbers in Zₚ domain, and ID is representative of the identification, and
the first encryption method is to apply a one-way function to ID, the second encryption information is ID·Y^{r}, wherein Y=e(g, g)^{y},
the first decryption information is represented as g^{t·r}, wherein corresponding t values of different decryption data of the first decryption information are different from each other,
the second decryption information is represented as g^{y/t}, wherein second decryption information and decryption data associated with the same logon verification correspond to the same t value,
the decryption method corresponding to the second encryption method is ID·Y^{r}/e(g^{y/t}, g^{t·r}).

11. A computer program for causing an information processing apparatus to perform the steps of:
obtaining from a certificate of a user, for a first logon verification, first encryption information, second encryption information, and first decryption data of first decryption information, wherein the first encryption information is obtained by encrypting an unique identification of the user according to a first encryption method, the second encryption information is obtained by encrypting the identification according to a second encryption method, the first decryption information comprises at least one piece of decryption data each associated with a corresponding logon verification and the first decryption data is associated with the first logon verification;
decrypting, based on second decryption information associated with the first logon verification and the first decryption data, the second encryption information according to a decryption method corresponding to the second encryption method to obtain the identification;
encrypting the obtained identification according to the first encryption method to obtain third encryption information; and
comparing the first encryption information with the third encryption information, and confirming the first logon verification successful in case that the first encryption information is identical to the third encryption information.

12. A computer-readable recording medium having a program recorded thereon for causing a computer to perform the steps of:
obtaining from a certificate of a user, for a first logon verification, first encryption information, second encryption information, and first decryption data in first decryption information, wherein the first encryption information is obtained by encrypting an unique identification of the user according to a first encryption method, the second encryption information is obtained by encrypting the identification according to a second encryption method, the first decryption information comprises at least one piece of decryption data each associated with a corresponding logon verification and the first decryption data is associated with the first logon verification;
decrypting, based on second decryption information associated with the first logon verification and the first decryption data, the second encryption information according to a decryption method corresponding to the second encryption method to obtain the identification;
encrypting the obtained identification according to the first encryption method to obtain third encryption information; and
comparing the first encryption information with the third encryption information, and confirming the first logon verification successful in case that the first encryption information is identical to the third encryption information.

13. A logon verification system, comprising:
an authorizing center configured to provide a user with a certificate for logging on at least one service node, and provide each service node with respective second decryption information for executing a corresponding logon verification, the certificate including first encryption information, second encryption information, and first decryption information which comprises at least one piece of decryption data each associated with a corresponding logon verification, wherein the first encryption information is obtained by encrypting an unique identification of the user according to a first encryption method, the second encryption information is obtained by encrypting the identification according to a second encryption method; and
the at least one service node, each corresponding to a logon verification apparatus configured to execute a corresponding logon verification of the user, the logon verification apparatus comprising:
an obtaining device configured to obtain in the certificate of the user, the first encryption information, the second encryption information, and corresponding decryption data in the first decryption information;
a decrypting device configured to decrypt, based on the second decryption information associated with the logon verification to be performed and the decryption data associated with the logon verification to performed, the second encryption information according to a decryption method corresponding to the second encryption method to obtain the identification;
an encrypting device configured to encrypt the identification obtained by the decrypting device according to the first encryption method to obtain third encryption information; and
a verifying device configured to compare the first encryption information with the third encryption information, in case that the first encryption information is identical to the third encryption information, confirm the logon verification successful and allow the user to access corresponding functions on the service node.

14. The logon verification system according to claim 13, wherein one of the logon verification apparatus may further comprises
a receiving device configured to receive from another logon verification apparatus a notification notifying that the another apparatus is going to perform another logon verification for the user, wherein the obtaining device of the one logon verification apparatus is further configured to obtain content of the certificate in response to the notification; and
a transmitting device, configured to transmit to the another logon verification apparatus the obtained content of the certificate, and
wherein the obtaining device of the another apparatus comprises:
a transmitting unit configured to transmit to the one logon verification apparatus a notification notifying that the another apparatus is going to perform another logon verification; and
a receiving unit configured to receive from the one logon verification apparatus content of the certificate returned in response to the notification.

15. The logon verification system according to claim 13, wherein the verifying device is further configured to, in case that the first encryption information is identical to the third encryption information and the identification is not revoked, confirm the logon verification successful.

16. The logon verification system according to claim 13, wherein G1 is representative of a bilinear group whose order is a prime number p, g is a generator of G1, e:G₁×G₁→G₂ represents a bilinear mapping, t, r, y are random numbers in Zₚ domain, and ID is representative of the identification, and
the first encryption method is to apply a one-way function to ID, the second encryption information is ID·Y^{r}, wherein Y=e(g, g)^{y},
the first decryption information is represented as g^{t·r}, wherein corresponding t values of different decryption data of the first decryption information are different from each other,
the second decryption information is represented as g^{y/t}, wherein second decryption information and decryption data associated with the same logon verification correspond to the same t value,
the decryption method corresponding to the second encryption method is ID·Y^{r}/e(g^{y/t}, g^{t·r}).

17. An information recording medium having stored thereon a certificate for a user to log on at least one service node, the certificate including:
first encryption information, which is obtained by encrypting an unique identification of the user according to a first encryption method;
second encryption information, which is obtained by encrypting the identification according to a second encryption method; and
first decryption information which comprises at least one piece of decryption data each associated with a corresponding logon verification.

18. A method of performing logon verification, comprising:
providing a user with a certificate, and providing logon verification apparatus which perform corresponding logon verification with second decryption information associated with the corresponding logon verification, the certificate including first encryption information, second encryption information, and first decryption information, wherein the first encryption information is obtained by encrypting an unique identification of the user according to a first encryption method, the second encryption information is obtained by encrypting the identification according to a second encryption method, the first decrypting information comprises at least one piece of decryption data each associated with a corresponding logon verification; and
by one of the logon verification apparatus:
obtaining from the certificate of the user, for a first logon verification, first encryption information, second encryption information, and first decryption data in first decryption information, the first decryption data is associated with the first logon verification;
decrypting, based on second decryption information associated with the first logon verification to be performed and the first decryption data, the second encryption information according to a decryption method corresponding to the second encryption method to obtain the identification;
encrypting the obtained identification according to the first encryption method to obtain third encryption information; and
comparing the first encryption information with the third encryption information, and confirm the first logon verification successful in case that the first encryption information is identical to the third encryption information.

19. The method of performing logon verification according to claim 18, further comprising:
by the one logon verification apparatus:
receiving from another logon verification apparatus among the logon verification apparatus a notification notifying that the another logon verification apparatus is going to perform a second logon verification for the user;
obtaining content of the certificate in response to the notification; and
transmitting to the another logon verification apparatus the obtained content of the certificate, and
by the another logon verification apparatus:
transmitting to the one logon verification apparatus a notification notifying that the another logon verification apparatus is going to perform a second logon verification for the user;
receiving from the one logon verification apparatus content of the certificate returned in response to the notification;
obtaining the first encryption information, the second encryption information, and second decryption data of the first decryption information, wherein the second decryption data is associated with the second logon verification;
decrypting, based on second decryption information associated with the second logon verification and the second decryption data, the second encryption information according to a decryption method corresponding to the second encryption method to obtain the identification;
encrypting the obtained identification according to the first encryption method to obtain fourth encryption information; and
comparing the first encryption information with the fourth encryption information, and confirm the second logon verification successful in case that the first encryption information is identical to the fourth encryption information.

20. The method of performing logon verification according to claim 18, wherein G1 is representative of a bilinear group whose order is a prime number p, g is a generator of G1, e:G₁×G₁→G₂ represents a bilinear mapping, t, r, y are random numbers in Zₚ domain, and ID is representative of the identification, and
the first encryption method is to apply a one-way function to ID, the second encryption information is ID·Y^{r}, wherein Y=e(g, g)^{y},
the first decryption information is represented as g^{t·r}, wherein corresponding t values of different decryption data of the first decryption information are different from each other,
the second decryption information is represented as g^{y/t}, wherein second decryption information and decryption data associated with the same logon verification correspond to the same t value,
the decryption method corresponding to the second encryption method is ID·Y^{r}/e(g^{y/t}, g^{t·r}).
